(19) United States
(12) Patent Application Publication
(10) Pub. No.: US 2012/0313420 A1
(43) Pub. Date: Dec. 13, 2012

(54) PNEUMATIC CUSHION, ACTUATOR AND VEHICLE SEAT

(75) Inventors: WOLFGANG BEYERLEIN, MITTELESCHENBACH (DE); WOLFGANG FÜRNROHR, BISSINGEN (DE); NORBERT BLOHM, WEISSENBURG (DE)

(73) Assignee: ALFMEIER PRAEZISION AG, TREUCHTLINGEN (DE)

(21) Appl. No.: 13/411,074

(22) Filed: Mar. 2, 2012

Related U.S. Application Data
(60) Provisional application No. 61/570,531, filed on Dec. 14, 2011.

(30) Foreign Application Priority Data
Dec. 14, 2010 (DE) 10 2010 054 487.6

(51) Int. Cl. B60N 2/44; B32B 1/08

(52) U.S. Cl. 297/452.41; 428/35.2; 428/35.5

(57) ABSTRACT

A film bladder, in particular for a vehicle seat, has an upper and a lower film wall and at least one longitudinal welded seam. The upper and the lower film wall in the collapsed installed state of the film bladder bear against one another and form a flat structure which is defined to the side by longitudinal side edges. The longitudinal welded seam of the film bladder is provided in a film region between the two longitudinal side edges of the film bladder.

The invention relates to a film bladder, in particular for a vehicle seat, comprising an upper and a lower film wall and comprising at least one longitudinal welded seam, wherein the upper and the lower film wall in the collapsed installed state of the film bladder bear against one another and form a flat structure which is defined to the side by longitudinal side edges.

For example, in virtually all comfort systems which are based on pneumatic principles in seats, in particular in vehicle seats, air bags and/or air bladders are used as actuators for adjusting the contour of the seat, hereinafter referred to in brief as bladders. Conventionally, such bladders consist of two thin plastics films and/or blanks made of plastics films, for example having a thickness of 0.3 to 0.5 mm, in particular made of TPU (thermoplastic polyurethane). By filling and emptying such film bladders, different functions may be implemented in the seat. For example, lumbar applications, side restraints in the armrest and/or backrest and seat surface of the respective seat, a seat depth adjuster, massage systems and optionally also linear drives are included therein, and which in particular may be provided in each case by a stack of bladders, i.e. by arranging bladders in succession.

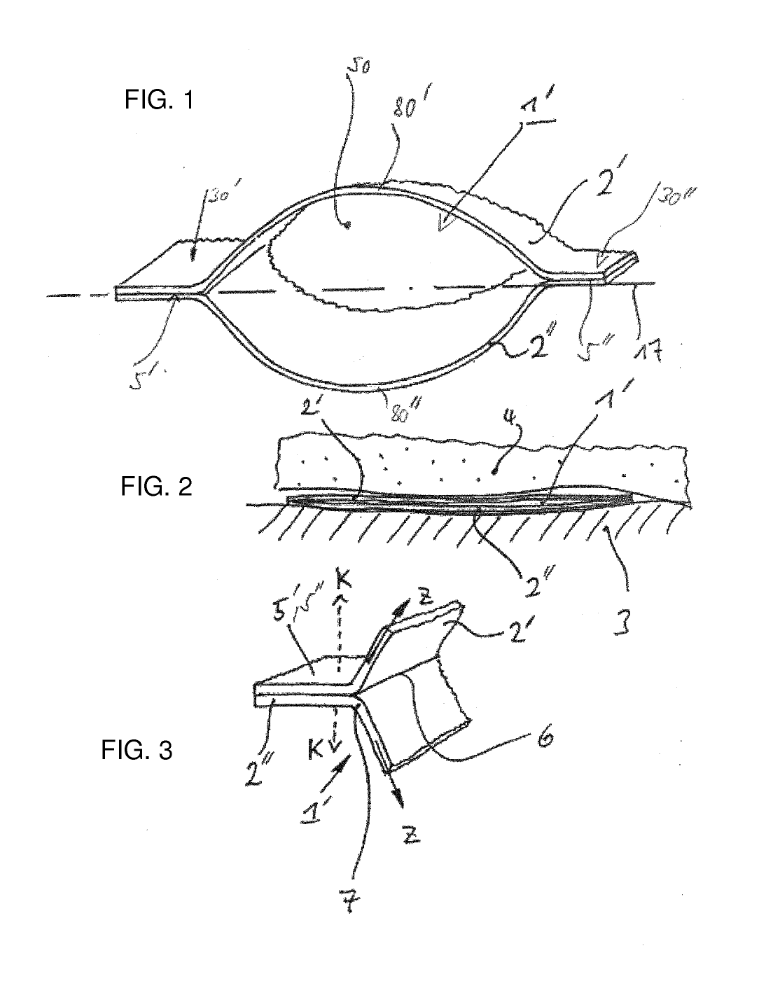

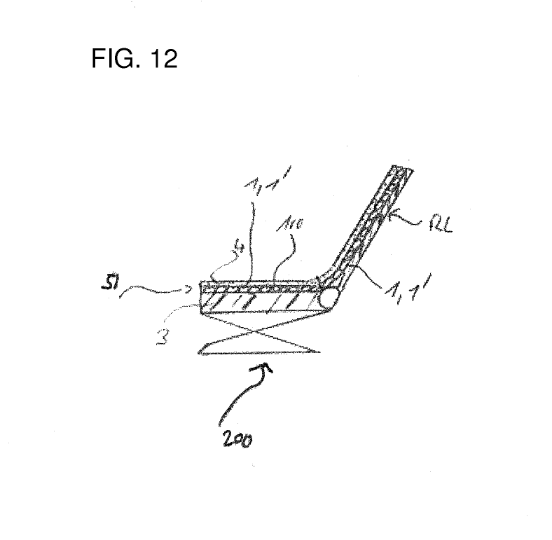

A film bladder 1 in the finished installed state, for example integrated in a seat part SI (see FIG. 12) and/or a backrest RL of a vehicle seat 200, bears against a supporting structure 3 in the deflated, i.e. collapsed, state in a more or less planar manner (FIG. 2). On its side remote from the supporting structure 3, the bladder 1 is enclosed by a padded material 4. The bladder 1 is thus arranged between two seat structures 3, 4 of the vehicle seat 200. If the bladder 1 is filled with air, it increases its volume as shown, for example, in FIG. 1, wherein the padded material 4 is moved away from the supporting structure 3. Depending on the application, the bladder is subjected to an internal pressure of up to 500 hPa. For producing a bladder, such as for example 1, conventionally two planar plastics film blanks 2′, 2″, of approximately the same geometric shape, for example with substantially the same rectangular shape, are superimposed substantially covering one another. On their two outer, i.e. left-hand and right-hand, longitudinal side edge zones 30′, 30″, in each case they are joined together, forming a longitudinal welded seam 5′, 5″, preferably by a high-frequency welding method. Thus the film bladder 1 has two longitudinal welded seams 5′, 5″ on its two outer longitudinal side edges 30′, 30″, whilst between said longitudinal side edges the two plastics film blanks and/or film walls 2′, 2″ thereof arranged on top of one another are not joined together and are thus movable relative to one another. In the empty state of the film bladder 1, the two plastics film blanks 2′, 2″ thereof are superimposed in a substantially congruent manner and are in contact with one another. Between the outer longitudinal side edge zones 30′, 30″ of the two plastics film blanks 2′, 2″, welded together in the longitudinal direction of the film bladder 1, a portion 80′ of the first plastics film blank 2′ and a portion 80″ of the second plastics film blank 2″ are thus movably arranged, such that said plastics film blanks bulge out when air is blown into the interior 50 of the film bladder 1′, i.e. in each case they adopt an outwardly bulged shape. In the inflated state of the film bladder 1′, the left-hand and right-hand longitudinal side edge zones 30′, 30″ of the film bladder 1′ protrude outwardly to the side into a common flat plane 17 relative to the bulged region of the film bladder 1′. In this case, primarily the respective longitudinal welded seam 5′, 5″ is subject to load. In the inflated state, the film portions 80′, 80″ of the plastics film blanks 2′, 2″ adjacent to the respective welded seam 5′, 5″ exert a tensile force Z which loads the respective welded seam 5′, 5″ mainly in the region of the joint 6 where the two plastics films 2′, 2″ merge with the respective welded seam region, viewed from the interior 50 of the film bladder 1′. In this case, a force component K is produced, extending approximately at right-angles to the flat plane 17 of the respective welded seam 5′, 5″. This leads over time to a separation and/or peeling of the respective welded seam 5′, 5″ or to a rupture of the plastics film blanks 2′, 2″ in the transition region 7 between its longitudinal side edge zones 30′, 30″ and the free portions 80′, 80″ of the two plastics film blanks 2′, 2″ which are able to move by letting in air and letting out air, in particular in dynamic applications, in which frequent deformation cycles and stroke cycles occur. Thus the respective film bladder may be subjected, for example in a massage system of a vehicle seat, to between 100000 and 1000000 stroke changes during the life of the vehicle seat. The continuous bending stress causes the respective welded seam to peel, i.e. the internal pressure of the respective air filling the interior 50 of the inflated film bladder 1′ attempts to separate the welded-together longitudinal side edge zones, for example 30′, 30″ of the two plastics film blanks 2′, 2″, from one another again. This leads to a mechanically disadvantageous linear load on the inner welded contour edge 6 (viewed from the interior 50 of the film bladder 1′) of the two respective welded-together longitudinal side edge zones 30′, 30″. The separation of the respective welded seam 5′, 5″ or a rupture of the plastics films 2′, 2″ in the transition region 7 leads to leakage of the bladder 1′.

The object of the invention is to provide a film bladder which withstands in an improved manner stresses occurring over the life required therefor, in particular a stationary load which is produced, for example, by continuously filling with air or dynamic loading which is produced, for example, by repeatedly alternating between filling with air and removing air.

This object is achieved according to the invention by a film bladder of the aforementioned type, in that the longitudinal welded seam of the film bladder is provided in a film region between the two longitudinal side edges of the film bladder.

In this manner, a film bladder is provided which meets the high loading demands, in particular bending, tensile and/or shear stresses, as already occur, for example, in the event of stationary loading by continuously filling with air, or primarily in the event of changing loads in dynamic applications with a high number of filling and emptying processes and the associated bending cycles. A film bladder configured according to the invention, accompanied by an actuator provided with at least one such film bladder, and a vehicle seat comprising at least one film bladder configured according to the invention or comprising at least one such actuator configured according to the invention, thus remain operational for a long service life under a wide variety of conditions.

In the film bladder configured according to the invention, the upper and lower film wall thereof in the collapsed installed state of the film bladder bear against one another and form a flat structure which is defined to the side by longitudinal side edges. Between these two longitudinal side edges the respective longitudinal welded seam is arranged in a film portion of the film bladder, and which in the empty state of the film bladder bears in a substantially loose manner flat against the opposing film portion of the film bladder, and when the film bladder is inflated is movable relative thereto. If the longitudinal welded seam, however, were to be arranged on a longitudinal side edge of the film bladder, this would hinder a complete flattening of the film bladder in the empty state. Moreover, a longitudinal welded seam arranged on one longitudinal side edge in the inflated state and/or primarily when changing between filling and emptying the film bladder would be subject to inadmissibly high bending, tensile and/or shear stresses of the film bladder, as has been explained above with reference to the exemplary embodiment of a conventionally configured film bladder of FIGS. 1, 2, 3.

As the respective longitudinal welded seam of the film bladder according to the invention is provided between the two longitudinal side edges thereof in a film region, in which the film bladder when filled with air, or other filling medium, in particular filling gas, expands and flattens when emptied, and not on a longitudinal side edge of the film bladder, a separation of the longitudinal welded seam or a rupture of one or more plastics films of the film bladder, in particular in the transition region between the longitudinal welded seam and the portions of the plastics film adjacent to the longitudinal welded seam and/or in the region of the two longitudinal side edges of the film bladder, is reliably avoided over the desired operating life of the film bladder. Thus a film bladder is provided which remains reliably airtight, even after frequent deformation cycles and stroke cycles. The longitudinal welded seam in the solution according to the invention is thus no longer located in the region of the film bladder where the maximum bending, tensile stress and/or shear forces acting on the film bladder occur when the bladder performs a stroke by letting in air and subsequently letting out air, which could lead to peeling of the film ends connected together by the welded seam, but is located outside this region. When installing a film bladder according to the invention or, in particular, a plurality of film bladders configured according to the invention in a seat, in particular a vehicle seat, it may be ensured therefore that the respective film bladder remains operational and operates correctly over the required operating life of the seat.

According to an expedient development of the invention, the film bladder in the inflated installed state forms an elongate, tubular structure, in particular a flat, tunnel-like structure, or it adopts a substantially flattened geometric shape, such as for example a cuboidal, cylindrical or conical hollow body shape. In other words, the respective film bladder is expediently configured such that the clear width between its two longitudinal side edges is greater than the clear height of its interior. If the longitudinal welded seam is positioned between the two longitudinal side edges of the film bladder, which are the areas of greatest bending and/or curvature viewed along the contour path of the film bladder in the inflated state thereof, said longitudinal welded seam is provided in the flattened region of the film bladder, and is thus subjected to far fewer bending, tensile and/or shear stresses or at least not to inadmissibly high bending, tensile and/or shear stresses. As a result, the durability of the longitudinal welded seam is ensured in a simple manner.

In particular, it may be expedient if the respective longitudinal welded seam is provided approximately in the central region of the upper film wall and/or lower film wall between the two longitudinal side edges of the film bladder. Here, the film bladder in the inflated state is advantageously configured to be the flattest relative to its remaining peripheral surfaces so that it is substantially avoided that inadmissible bending, tensile and/or shear stresses are able to act on the longitudinal welded seam.

According to an advantageous development of the invention, the longitudinal welded seam is configured and arranged such that when filling the film bladder with air a tensile force, which is exerted by the portions adjacent to the longitudinal welded seam of the plastics film of the film bladder on the longitudinal welded seam thereof, acts in a direction which extends substantially parallel to the flat plane spanned by the longitudinal welded seam. As a result, a separation of the film ends of the film bladder welded together is substantially avoided in the region of the welded seam.

In this case, the film bladder may preferably be formed from a single plastics film or optionally from two plastics films which in each case have two film ends.

In particular, it may be expedient if the longitudinal welded seam is formed by the two opposing film ends of a plastics film or two plastics films being welded together with their inner faces, and by the longitudinal welded seam being folded over so that it extends along the outer face of the plastics film. By folding over the longitudinal welded seam such that said longitudinal welded seam follows the outer contour of the inflated film bladder, tensile forces perpendicular to the welded seam, which could lead to an undesired separation of the film ends of the film bladder welded together at that point, are substantially avoided.

It may be particularly advantageous if a longitudinal welded seam is formed between the two film ends of a plastics film or two plastics films by the inner face of the one film end facing the interior of the film bladder being positioned onto the outer face of the other film end remote from the interior of the film bladder, and a weld being performed in the overlapping region of the two film ends. By this overlapping of the film ends in a flush manner, the welded seam follows the contour path of the inflated film bladder so that tensile forces perpendicular to the welded seam, which could lead to an undesired separation of the film ends of the film bladder welded together at that point, are substantially avoided.

If a first longitudinal welded seam is provided in the upper film wall of the film bladder located between the two longitudinal side edges of the film bladder and a second longitudinal welded seam is provided in the lower film wall of the film bladder located between the two longitudinal side edges of the film bladder, it may be expedient if the first longitudinal welded seam is offset laterally and/or to the side relative to the second longitudinal welded seam. As a result, the two longitudinal welded seams do not bear against one another in the empty state of the film bladder so that damage thereof, for example by the effects of abrasion, is substantially avoided.

According to a further advantageous development of the invention, the front ends of the film bladder extending transversely to the longitudinal extent of the film bladder are welded together, forming a welded seam. As a result, a hollow body which is enclosed all around is produced for the respective film bladder.

It may be expedient if fixing tabs are integrally formed on the front ends of the respective film bladder. As a result, a plurality of film bladders may be fastened easily in terms of production technology to a supporting film and mounted as a unit, for example, in a vehicle seat.

The invention also relates to an actuator comprising a film bladder or a plurality of film bladders, which are in each case formed according to the construction principle according to the invention. An advantageous actuator may be formed, for example, by one or more film bladders being fastened on a supporting film.

The invention further relates, in particular, to a vehicle seat comprising at least one actuator according to the invention. The actuator may in this case provide, in particular, a massage system, a lumbar support, side restraints in the armrest and seat surface, a seat depth adjuster and/or a linear drive. To this end, it may be advantageous if the actuator is arranged with one or more film bladders between a first and a second seat structure of the vehicle seat.

Other advantageous developments of the invention are set forth in the sub-claims.

The invention and its advantageous developments and the advantages thereof are explained hereinafter in more detail with reference to the drawings.

In the drawings, in each case in a schematic view or basic sketch:

FIG. 1 shows a film bladder of conventional design in the inflated state, in which two blank plastics films lie flat on top of one another on their two side edges and are welded together at that point,

FIG. 2 shows the film bladder of FIG. 1 in the empty, i.e. collapsed, state,

FIG. 3 shows in detail a welded seam in the region of a longitudinal side edge of the film bladder of FIG. 1,

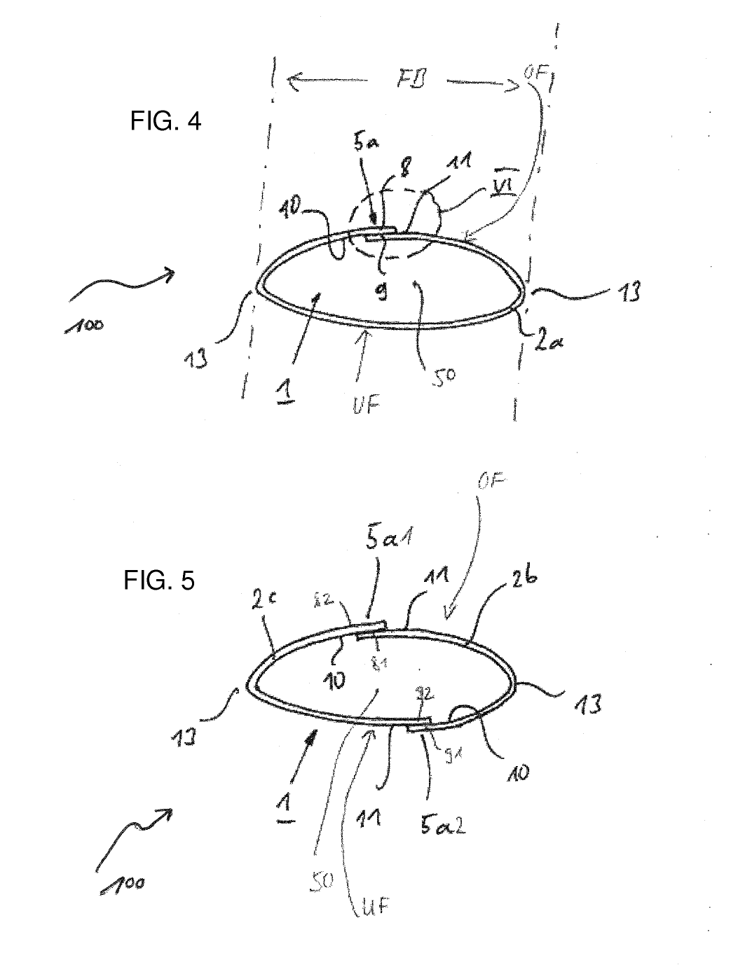

FIG. 4 shows a first advantageous exemplary embodiment of a film bladder configured according to the invention in a sectional view, viewed transversely to the longitudinal extent thereof,

FIG. 5 shows a second advantageous exemplary embodiment of a film bladder configured according to the invention in a sectional view, viewed transversely to the longitudinal extent thereof,

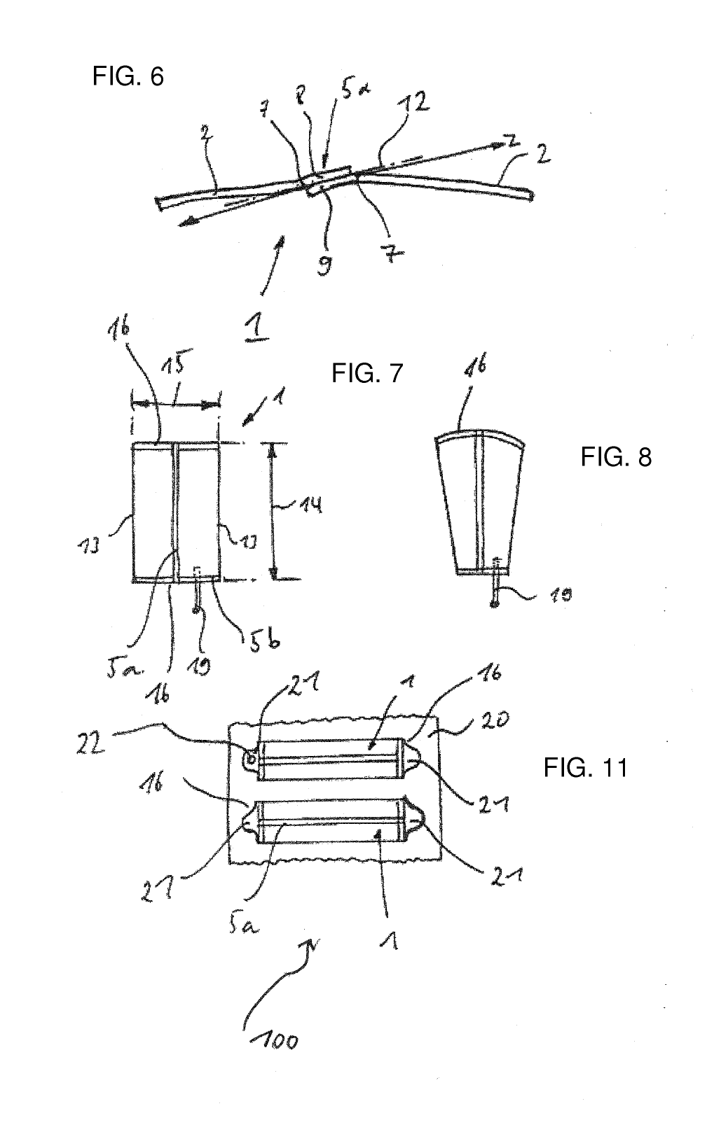

FIG. 6 shows in detail a welded seam of the film bladder of FIG. 4,

FIGS. 7, 8 show in schematic plan view different advantageous geometric shapes of a film bladder produced according to the construction principle according to the invention,

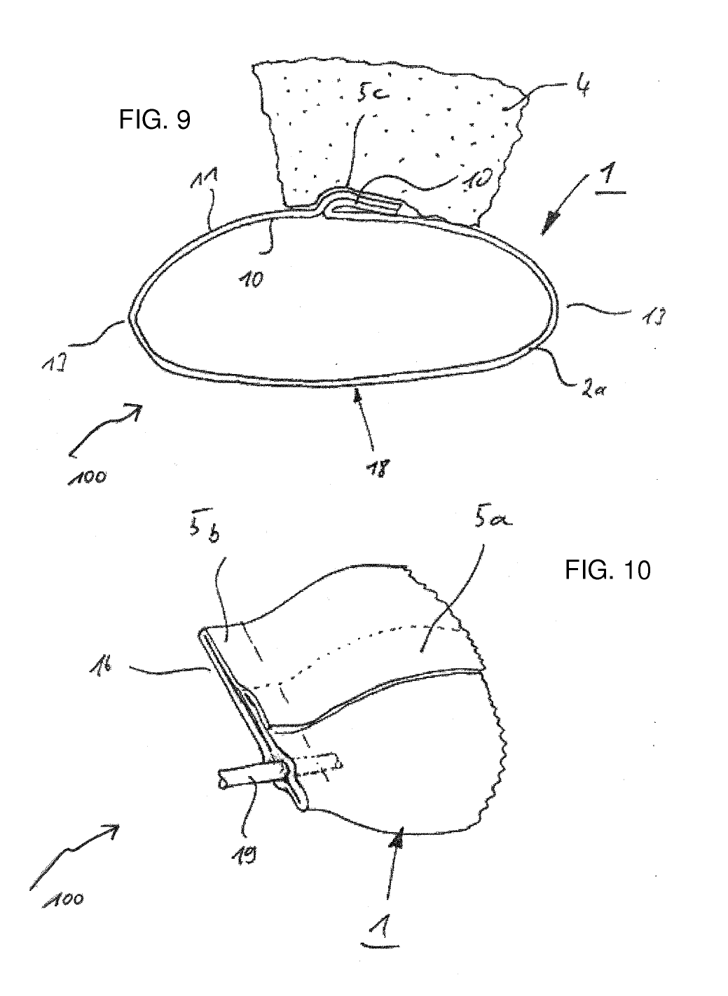

FIG. 9 shows a third advantageous exemplary embodiment of a film bladder configured according to the invention in a sectional view, viewed transversely to the longitudinal extent thereof,

FIG. 10 shows the film bladder of FIG. 9 in the region of a front end in a perspective view, viewed from above,

FIG. 11 shows in plan view a supporting film with a plurality of film bladders configured according to the invention, and

FIG. 12 shows in schematic side view a vehicle seat, which has an actuator comprising film bladders configured according to the invention.

Only those components of a film bladder which are required for understanding the invention are provided with reference numerals and described in FIGS. 1-12. Otherwise, elements with the same function and mode of operation are provided in each case with the same reference numerals in FIGS. 1-12.

In order to make a film bladder more robust and/or more resistant relative to mechanical loads which act on said film bladder, for example due to it being respectively filled with air, the longitudinal welded seam of the film bladder is provided in a film region between the two longitudinal side edges of the film bladder. In this case, the film bladder has an upper and a lower film wall which in the collapsed installed state of the film bladder bear against one another and form a flat structure which is defined to the side by longitudinal side edges.

FIGS. 4 and 6 illustrate a first advantageous variant of a film bladder 1 comprising such a design according to the invention. Here the film bladder in the inflated state has a flattened cylindrical shape, in spatial terms. Viewed transversely to its longitudinal extent, it is shaped approximately in the manner of an ellipse. In the variant shown in FIGS. 4 and 6, in the region FB between the two longitudinal side edges 13 of the film bladder 1, a longitudinal welded seam 5a is formed between two film ends 8, 9 of an individual plastics film 2a by the inner face 10 of the one film end 8 facing the bladder interior 50 being positioned onto the outer face 11 of the other film end 9 remote from the bladder interior, and a weld being performed in the overlapping region. As indicated in the view of FIG. 6, the detail VI of FIG. 4, the tensile force Z of the portions of the plastics film 2a adjacent to the longitudinal welded seam 5a acts on the longitudinal welded seam 5a in a direction which extends substantially parallel to the flat plane 12 spanned by the longitudinal welded seam 5a. As a result, even when the film bladder 1 is completely filled and/or inflated with air or other filling gas or filling medium, a force is not introduced vertically into the longitudinal welded seam, outwardly away from the flat plane 12 thereof, or is negligible, as shown in FIG. 3, so that the overlapping film ends 8, 9 in the longitudinal welded seam 5a are not forced apart, nor are the transition regions 7, in the form which is present in the prior art, subject to bending stress.

A film bladder 1 with a longitudinal welded seam 5a of the aforementioned type may be produced in an advantageous manner according to FIG. 4 from a single plastics film 2a, by opposing film ends 8, 9 of the plastics film 2a being overlapped in a flush manner and joined together in the disclosed manner, in particular by high-frequency welding. By the flush overlapping of the two film ends 8, 9, between said film ends a contact surface 12 is formed which substantially follows the contour of the film ends 8, 9 and the film portions adjacent to the film ends 8, 9 in the inflated state of the film bladder. If the film bladder 1 is filled with air or another filling medium, as a result the contact surface 12 is only subjected to a tensile force which, in the region of the contact surface 12 of the longitudinal welded seam 5a, substantially acts with a tangential force component on the film ends 8, 9 and is oriented away from the front faces thereof. The longitudinal welded seam 5a is preferably arranged in a film region, such as for example in this case on the upper film wall OF of the plastics film 2a, which in the empty installed state of the film bladder 1 bears flat against the opposing film region, such as for example in this case the lower film wall UF of the plastics film 2a. If a longitudinal welded seam 5a were to be arranged on a longitudinal side edge 13 of the film bladder 1, this would hinder a complete flattening of the film bladder 1 in the empty state. Moreover, a longitudinal welded seam 5a arranged on a longitudinal side edge 13 would be subjected to continuous bending stress when the film bladder 1 is filled and emptied.

Advantageously, the longitudinal welded seam 5a is provided approximately in the central region of the upper film wall OF between the left and right longitudinal side edges 13 of the film bladder 1. As a result, it is positioned at a point in which the common contact surface 12 extends between the overlapping inner face 10 of the radially outer film end 8 and the outer face 11 of the radially inner film end 9 substantially parallel to the central flattened plane of the upper film wall OF in the inflated state of the film bladder 1. As a result, inadmissible tensile stresses perpendicular to the contact surface 12 which could lead to a peeling and/or separation of the two film ends 8, 9 are substantially avoided.

Alternatively, the longitudinal welded seam 5a may also be attached in a similar manner to the lower film wall UF.

Preferably, the overlapping longitudinal welded seam 5a is attached, in particular, to the film wall which serves for fastening the film bladder, such as for example to a supporting film. As this film wall then bears against a bearing surface, and is held there or is fastened thereto, a separating force acting perpendicular to the contact surface 12 of the longitudinal welded seam 5a, which is oriented away from the bearing surface, may be partially or entirely absorbed or compensated, so that a separation of the film ends 8, 9 is additionally counteracted.

In the further advantageous exemplary embodiment shown in FIG. 5, the bladder 1 is formed from two plastics films 2b, 2c. It comprises, therefore, two of the above-described longitudinal welded seams 5a. These are denoted in FIG. 5 by 5a1, 5a2. The two welded seams 5a1, 5a2 may be arranged offset to the side, so that they do not bear against one another in the empty state of the bladder 1. In an upper region, the first longitudinal welded seam 5a1 is formed between a first film end 81 of the first plastics film 2b and a first film end 82 of the second plastics film 2c by the inner face 10 of the first film end 82 of the second plastics film 2c facing the interior 50 of the film bladder 1 being positioned onto the outer face 11 of the first film end 81 of the first plastics film 2b remote from the interior 50 of the film bladder 1, and a weld being performed in the overlapping region of these two first film ends 81, 82. Similarly, in a lower region the second longitudinal welded seam 5a2 is formed between a second film end 91 of the first plastics film 2b and a second film end 92 of the second plastics film 2c by the inner face 10 of the second film end 91 of the first plastics film 2b facing the interior 50 of the film bladder 1 being positioned on the outer face 11 of the second film end 92 of the second plastics film 2c remote from the interior 50 of the film bladder 1, and a weld being performed in the overlapping region of these two second film ends 91, 92.

Film bladders of the type under discussion here are generally elongate structures, i.e. they have a length 14 which is greater than their width 15 (FIG. 7). The longitudinal welded seam 5a extends substantially in the longitudinal direction of the film bladder 1. The front ends 16 of the bladder 1 extending transversely thereto are welded together on a welded seam 5b in a conventional manner as disclosed further above. The film regions connected together in the welded seam 5b extend in the flat plane 17 (FIG. 1) of the bladder 1. The front ends 16 may extend in a straight line, as shown in FIG. 7, or even have a curved path approximately corresponding to FIG. 8.

Expediently, the respective film bladder in the inflated installed state forms an elongate, tubular structure, in particular a flat, tunnel-like structure, or it adopts a substantially flattened cuboidal, cylindrical or conical hollow body shape. If the longitudinal welded seam in the flattened region is attached between the two longitudinal side edges, inadmissible separating stresses/tensile stresses perpendicular to the welded seam and/or bending stresses in the region of the welded seam are substantially avoided. As a result, the welded seam is substantially prevented from being subjected to inadmissible stresses.

In summary, therefore, a film bladder, in particular for a vehicle seat, is provided which has an upper and a lower film wall. The upper and the lower film wall in the collapsed installed state of the film bladder bear against one another and form a flat structure which is defined to the side by longitudinal side edges. The respective longitudinal welded seam of the film bladder is provided according to the invention in the region, in particular approximately in the central region, between said two longitudinal side edges on the upper and/or lower film wall. In this manner, the respective longitudinal welded seam is positioned outside the regions of the longitudinal side edges which are subjected by all regions of the inflated film bladder to the greatest bending and thus associated tensile stress (in the direction of extension of the plastics film). By the arrangement of the respective longitudinal welded seam in the less curved intermediate region of the film bladder between the two longitudinal side edges thereof, the longitudinal welded seam in the inflated state of the film bladder is subjected to lower bending, tensile and/or peeling forces, which could lead to a separation of the longitudinal welded seam, than might be the case in the region of the longitudinal side edges.

In a further advantageous embodiment (see FIG. 9) of the film bladder configured according to the invention, the welded seam is formed in a conventional manner as described above (FIGS. 1 to 3). In the case of a bladder formed from only one plastics film 2a, opposing film ends 8, 9 of a film blank are welded together by their inner faces 10. The corresponding welded seam 5c, however, does not form the side edge 13 of the bladder but is arranged on a region of the bladder 1 located between the side edges 13. The welded seam 5c is folded over so that it extends along the outer face 11 of the plastics film 2a. Due to a padded material 4 encasing the bladder 1, the welded seam 5c is held in this position even in the inflated state (see FIG. 9).

It is also conceivable that a welded seam 5c is provided on the side of the bladder 1 facing the supporting structure 3, at a point 18, i.e. in this case the bladder 1 is formed from two plastics films. The welded seam 5c in its laterally folded over state may also be fixed by bonding or welding to the outer face 11 of the plastics film 2a.

A pipe 19, serving for inflation and deflation, is supplied via the welded seam 5b of the front ends 16 which are welded together in the conventional manner.

Frequently in a seat, in particular a vehicle seat, an assembly of a plurality of bladders 1 is desired. In order not to have to mount in such a case individual bladders in the seat and to fix them to the supporting structure in a specific position and alignment, it is expedient to arrange a plurality of bladders 1 on a supporting film 20 and to fasten said bladders thereto (see FIG. 11). The bladders 1 may be fastened to the supporting film 20, for example, by fixing tabs 21 being integrally formed on the front ends 16 of the bladders 1, and which are connected to the supporting film 20, for example, by high-frequency welding or a plastics rivet 22.

In FIG. 12, by way of example, a vehicle seat 200 is shown schematically in side view, and which between two seat structures 3, 4 comprises an actuator 100 in its seat surface SI and in its backrest RL. The actuator has a supporting film on which a plurality of film bladders formed according to the invention are attached, for example corresponding to the embodiment of FIG. 4.

1-14. (canceled)

15. A film bladder, comprising:
an upper film wall; and
a lower film wall, said upper and lower film walls defining at least one longitudinal welded seam, said upper and lower film walls in a collapsed installed state of the film bladder bear against one another and form a flat structure having sides with two longitudinal side edges, said longitudinal welded seam disposed in a film region between said two longitudinal side edges.

16. The film bladder according to claim 15, wherein in an inflated installed state the film bladder forms an elongate, tubular structure or adopts a substantially flattened geometric shape.

17. The film bladder according to claim 15, wherein said longitudinal welded seam is provided approximately in a central region of at least one of said upper film wall or said lower film wall between said two longitudinal side edges.

18. The film bladder according to claim 15, further comprising a plastic film forming said upper and lower film walls, said longitudinal welded seam configured and disposed such that when filling the film bladder with air a tensile force, which is exerted by portions adjacent to said longitudinal welded seam of said plastic film on said longitudinal welded seam thereof, acts in a direction which extends substantially parallel to a flat plane spanned by said longitudinal welded seam.

19. The film bladder according to claim 15, wherein the film bladder is formed from one of a single plastic film or from two plastics films which in each case have two film ends.

20. The film bladder according to claim 19, wherein said longitudinal welded seam is formed by two opposing film ends of said single plastic film or from said two plastics films being welded together with their inner faces, and by said longitudinal welded seam being folded over so that it extends along an outer face of said plastic film.

21. The film bladder according to claim 19, wherein said longitudinal welded seam is formed between two film ends of said single plastic film or said plastic films by an inner face of a first film end facing an interior of the film bladder being positioned onto an outer face of a second film end remote from said interior of the film bladder, and a weld being performed in an overlapping region of said two film ends.

22. The film bladder according to claim 15, wherein said longitudinal seam is one of two longitudinal seams including a first longitudinal welded seam in said upper film wall of the film bladder disposed between said two longitudinal side edges of the film bladder and a second longitudinal welded seam in said lower film wall of the film bladder disposed between said two longitudinal side edges of the film bladder and are disposed offset to a side with respect to one another.

23. The film bladder according to claim 15, wherein the film bladder has front ends extending transversely to a longitudinal extent of the film bladder and are welded together, forming said longitudinal welded seam.

24. The film bladder according to claim 23, further comprising fixing tabs integrally formed on said front ends for fastening to a supporting film.

25. The film bladder according to claim 15, wherein the film bladder is used in a vehicle seat.

26. The film bladder according to claim 15, wherein in an inflated installed state the film bladder forms an elongate, flat, tunnel-like structure, or adopts a substantially flattened geometric shape selected from the group consisting of a cuboidal hollow body shape, a cylindrical hollow body shape and a conical hollow body shape.

27. An actuator, comprising:
a film bladder, containing:
an upper film wall; and
a lower film wall, said upper and lower film walls defining at least one longitudinal welded seam, said upper and lower film walls in a collapsed installed state of the film bladder bear against one another and form a flat structure having sides with two longitudinal side edges, said longitudinal welded seam disposed in a film region between said two longitudinal side edges.

28. The actuator according to claim 27, further comprising a supporting film, said film bladder is fastened on said supporting film.

29. An actuator, comprising:
a plurality of film bladders, each containing:
an upper film wall; and
a lower film wall, said upper and lower film walls defining at least one longitudinal welded seam, said upper and lower film walls in a collapsed installed state of the film bladder bear against one another and form a flat structure having sides with two longitudinal side edges, said longitudinal welded seam disposed in a film region between said two longitudinal side edges.

30. The actuator according to claim 29, further comprising a supporting film, said film bladders are fastened on said supporting film.

31. A vehicle seat, comprising:
an actuator; and
at least film bladder actuated by said actuator, said film bladder containing:
an upper film wall; and
a lower film wall, said upper and lower film walls defining at least one longitudinal welded seam, said upper and lower film walls in a collapsed installed state of the film bladder bear against one another and form a flat structure having sides with two longitudinal side edges, said longitudinal welded seam disposed in a film region between said two longitudinal side edges.

32. The vehicle seat according to claim 31, further comprising:
a first seat structure;
a second seat structure; and
said actuator with said at least one film bladder are disposed between said first and second seat structures.
